(19) United States
(12) Patent Application Publication
(10) Pub. No.: US 2023/0207826 A1
(43) Pub. Date: Jun. 29, 2023

(54) ANODE CONTAINING MULTI-COMPOSITE CONDUCTIVE AGENT AND LITHIUM SECONDARY BATTERY INCLUDING THE SAME

(71) Applicant: KOREA ELECTRONICS TECHNOLOGY INSTITUTE, Seongnam-si (KR)

(72) Inventors: Sanggil WOO, Suwon-si (KR); Jenam LEE, Seongnam-si (KR)

(21) Appl. No.: 18/065,110

(22) Filed: Dec. 13, 2022

(30) Foreign Application Priority Data
Dec. 23, 2021 (KR) 10-2021-0186196

(51) Int. Cl. H01M 4/62

(52) U.S. Cl. CPC H01M 4/625; H01M 4/626; H01M 2004/027

(57) ABSTRACT

An anode containing a multi-composite conductive agent and a lithium secondary battery including the anode are proposed. The anode may include an anode active material containing a carbon-based material and a metal-based compound, a binder, and a multi-composite conductive agent containing a carbon-based conductive agent and a metal-based conductive agent having different physical properties and shapes. According to some embodiments, the anode can increase energy density and also improve electrical conductivity and electron mobility.

### CROSS-REFERENCE TO RELATED APPLICATION

The present application claims priority to Korean Patent Application No. 10-2021-0186196 filed on Dec. 23, 2021 in the Korean Intellectual Property Office, the entire disclosure of which is incorporated herein by reference.

### BACKGROUND

### Technical Field

The present disclosure relates to a lithium secondary battery. More particularly, the present disclosure relates to an anode containing a multi-composite conductive agent capable of increasing energy density and also improving electrical conductivity and electron mobility, and to a lithium secondary battery including the anode.

### Description of Related Technology

With the expansion of mobile devices and ubiquitous computing networks in response to the growth of the information society, the demand for energy storage device technology capable of supplying power to corresponding electronic devices is unprecedentedly high. Among energy storage device technologies, secondary battery technology is the most suitable technology for energy storage and utilization in various fields. The secondary battery technology has technical importance because it can be applied to large-sized devices such as electric vehicles and power storage devices as well as personal IT devices because of the ability to miniaturize batteries

### SUMMARY

One aspect is an anode containing a multi-composite conductive agent capable of securing lifetime stability by improving the reactivity of graphite and maintaining the stable electrical conductivity of a silicon compound whose usage will increase henceforth, and also provide a lithium secondary battery including the anode.

Another aspect is an anode containing a multi-composite conductive agent capable of maximizing the energy density of a lithium secondary battery by minimizing the contents of a conductive agent and a binder in the anode, and also provide the lithium secondary battery including the anode.

Another aspect is an anode containing a multi-composite conductive agent capable of improving rapid charging, high-power discharging, and lifespan characteristics by improving electrical conductivity and electron mobility in the anode, and also provide a lithium secondary battery including the anode.

Another aspect is an anode of a lithium secondary battery that includes an anode active material containing a carbon-based material and a metal-based compound; a binder; and a multi-composite conductive agent containing a carbon-based conductive agent and a metal-based conductive agent having different physical properties and shapes.

The carbon-based material may include at least one of graphite, soft carbon, and hard carbon.

The metal-based compound may include at least one of a silicon compound, a tin compound, and a zinc compound.

The multi-composite conductive agent may include at least one of Super-P, denka black, graphene, carbon nanofibers (CNF), and carbon nanotubes (CNT) as the carbon-based conductive agent, and include at least one of Ag, Au, Ca, Zn, Al, and alloys thereof as the metal-based conductive agent.

The carbon-based conductive agent and the metal-based conductive agent may have different shapes. The carbon-based conductive agent may have one shape among a particle, a fiber, and a tube, and the metal-based conductive agent may have one shape among a particle, a fiber, a wire, and a flake.

The carbon-based conductive agent may be a nanoparticle, and the metal-based conductive agent may be a nanowire.

In the multi-composite conductive agent, a content of the carbon-based conductive agent may be higher than a content of the metal-based conductive agent.

The anode active material may be 97 wt % or more, the binder may be 2 wt % or less, the multi-composite conductive agent may be 1 wt % or less, and a content of the binder may be higher than a content of the multi-composite conductive agent.

The carbon-based material may be graphite, the metal-based compound may be a silicon compound, the carbon-based conductive agent may be Super-P, and the metal-based conductive agent may be an Ag nanowire.

In addition, according to the present disclosure, a lithium secondary battery includes the above anode, a cathode, a separator, and an electrolyte.

According to the present disclosure, by using the multi-composite conductive agent including two or more types of conductive agents having different physical properties and shapes as the conductive agent of the anode, it is possible to minimize the contents of the multi-composite conductive agent and the binder in the anode and maximize the energy density of the lithium secondary battery. That is, the anode according to the present disclosure minimizes the content of the binder as well as the conductive agent by utilizing a difference in shape between the conductive agents included in the multi-composite conductive agent, thereby maximizing the content of the anode active material in the anode and also maximizing the energy density of the lithium secondary battery.

The multi-composite conductive agent according to the present disclosure improves the electrical conductivity and electron mobility in the anode, thereby improving rapid charging, high-power discharging, and lifespan characteristics of the lithium secondary battery. That is, by utilizing two or more types of conductive agents having different physical properties and shapes, the multi-composite conductive agent according to the present disclosure can efficiently configure an electron transfer path, increase affinity with lithium ions, exhibit high electrical conductivity, and enable a stable supply of ions and electrons. As a result, the anode containing the multi-composite conductive agent according to the present disclosure can improve the rapid charging, high-power discharging, and lifespan characteristics of the lithium secondary battery.

### BRIEF DESCRIPTION OF THE DRAWINGS

FIG. 1 is a view showing an anode assembly of a lithium secondary battery including an anode containing a multi-composite conductor according to the present disclosure.

FIGS. 2 to 4 are photographs showing images of anodes according to a comparative example and embodiments.

FIGS. 5 to 8 are graphs showing CC/CV ratios in rate-by-rate charging of anodes according to a comparative example and embodiments.

FIGS. 9 to 12B are graphs showing room temperature life characteristics of lithium secondary batteries including anodes according to a comparative example and embodiments, in which FIG. 9 is a graph showing discharge capacity, FIG. 10 is a graph showing capacity efficiency, FIGS. 11A and 11B are graphs showing a first cycle voltage profile, and FIGS. 12A and 12B are graphs showing a 200^{th} voltage profile.

### DETAILED DESCRIPTION

In the secondary battery technology, lithium secondary batteries, which can theoretically be designed with high operating voltage and capacity, are in the limelight because they can be designed with the highest energy density per weight and volume among commercially available secondary batteries. The lithium secondary battery generally includes a cathode formed of a transition metal oxide containing lithium, an anode capable of storing lithium, an electrolyte serving as a medium for delivering lithium ions, and a separator.

Here, the anode includes an anode active material, a binder, and a conductive agent. For the anode active material, technology development is being made toward improving the energy density of an electrode by mainly using graphite and mixing a small amount of a silicon-based compound. However, each of these two materials used as the anode active materials has a limitation.

First, because graphite currently implements almost all theoretical capacities, technology development is progressing in the direction of increasing the content in the electrode in order to improve the energy density. However, graphite has limitations in a lithium insertion direction and in increasing a reaction rate with lithium only with material's own electrical conductivity without a conductive agent. Therefore, graphite is a very unfavorable material in terms of rapid charging performance and battery stability at high power, which will be required henceforth.

Next, because the silicon-based compound has a high capacity per mass, it is used for high energy density of a battery and has excellent characteristics related to rapid charging. However, the silicon-based compound has very low electrical conductivity compared to graphite, so a large amount of conductive agent and an additional binder should be used. Unfortunately, this offsets the effect of increasing the energy density. Furthermore, because the silicon-based compound undergoes a large volume change when reacting with lithium, electrical contact is not continuously made sufficiently as the lifespan progresses, resulting in a rapid decrease in capacity. This makes it difficult to use a large amount of silicon compound for the anode.

Typically, in order to improve the reaction rate of the anode with lithium, methods of using a conductive agent with a large specific surface area or using graphene with high electrical conductivity have been developed. That is, such typical methods can improve rapid charging and high-power discharging characteristics because of increasing the reaction rate of the anode. However, even in these methods, it is difficult to reduce the content of a conductive agent, and because a large amount of binder is required due to the large specific surface area of the conductive agent, it has a limitation in that the energy density does not greatly increase.

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

A lithium secondary battery according to the present disclosure includes an anode, a cathode, a separator, and an electrolyte. The lithium secondary battery according to the present disclosure uses, except for the anode, a general cathode, separator, and electrolyte, so the following description will focus on the anode.

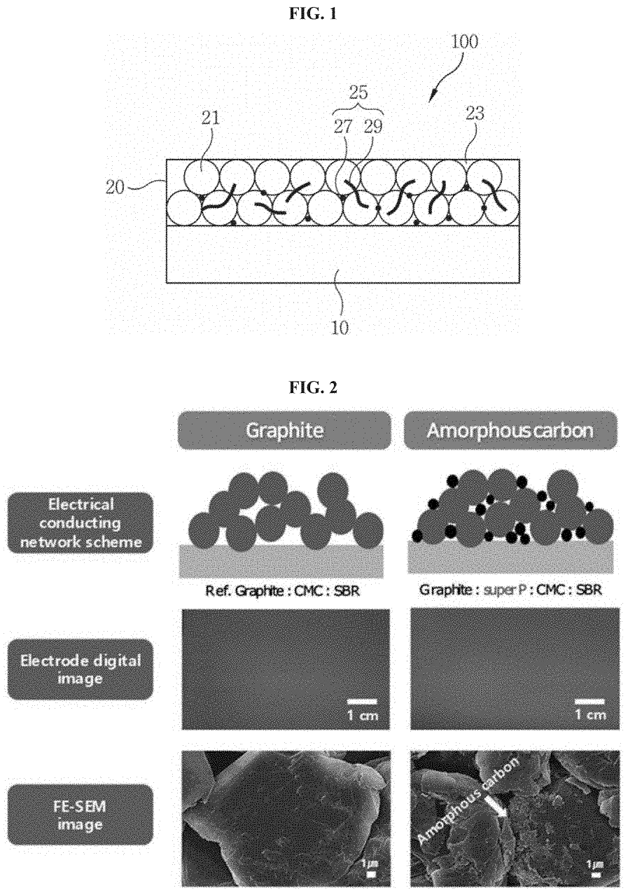

FIG. 1 is a view showing an anode assembly of a lithium secondary battery including an anode containing a multi-composite conductor according to the present disclosure.

Referring to FIG. 1, the anode assembly 100 according to the present disclosure includes an anode current collector 10 and an anode 20.

The anode current collector 10 supplies electrons to the anode 20 from an external circuit. For example, a copper thin film may be used as the anode current collector 10.

The anode 20 generates and consumes electrons through an electrochemical reaction. The anode 20 may be formed on the anode current collector 10 by a coating or roll-to-roll method.

The anode 20 according to the present disclosure includes an anode active material 21, a binder 23, and a multi-composite conductive agent 25. The anode 20 contains 97 wt % or more of the anode active material 21, 2 wt % or less of the binder 23, and 1 wt % or less of the multi-composite conductive agent 25. The content of the binder 23 may be higher than that of the multi-composite conductive agent 25.

The anode active material 21 contains a carbon-based material and may further include a metal-based compound.

The carbon-based material includes at least one of graphite, soft carbon, and hard carbon. For example, graphite may be used as the carbon-based material.

The metal-based compound includes at least one of a silicon compound, a tin compound, and a zinc compound. For example, a silicon compound may be used as the metal-based compound.

The binder 23 physically binds the anode active material 21 and the multi-composite conductive agent 25 and also physically binds the anode 20 to the anode current collector 10. As the binder 23, at least one of carboxymethyl cellulose (CMC), styrene butadiene rubber (SBR), acrylonitrile butadiene rubber, acrylic rubber, butyl rubber, fluoro rubber, polyvinyl alcohol, starch, hydroxypropyl cellulose, regenerated cellulose, polyvinyl alcohol (PVA), polyacrylic acid (PAA), polyethylene glycol (PEG), polyacrylonitrile (PAN), and polyacryl amide (PMA) may be used.

The multi-composite conductive agent 25 contains a carbon-based conductive agent 27 and a metal-based conductive agent 29 having different physical properties and shapes.

As the carbon-based conductive agent 27, a carbon-based material having high electrical conductivity and a large specific surface area is used. Amorphous carbon may be used as the carbon-based conductive agent 27. For example, amorphous carbon includes at least one of Super-P, denka black, graphene, carbon nanofibers (CNF), and carbon nanotubes (CNT).

As the metal-based conductive agent 29, a metal material having high electrical conductivity and high affinity with lithium is used. For example, the metal-based conductive agent 29 includes at least one of Ag, Au, Ca, Zn, Al, and alloys thereof.

The carbon-based conductive agent 27 and the metal-based conductive agent 29 may have different shapes. The carbon-based conductive agent 27 may have one shape among a particle, a fiber, and a tube. The metal-based conductive agent 29 may have one shape among a particle, a fiber, a wire, and a flake. For example, in the multi-composite conductive agent 25, the carbon-based conductive agent 27 may be a nanoparticle, and the metal-based conductive agent 29 may be a nanowire.

In the multi-composite conductive agent 25, the content of the carbon-based conductive agent 27 may be higher than that of the metal-based conductive agent 29.

According to the present disclosure, by using the multi-composite conductive agent 25 including two or more types of conductive agents having different physical properties and shapes as the conductive agent of the anode 20, it is possible to minimize the contents of the multi-composite conductive agent 25 and the binder 23 in the anode 20 and maximize the energy density of the lithium secondary battery. That is, the anode 20 according to the present disclosure minimizes the content of the binder 23 as well as the conductive agent by utilizing a difference in shape between the conductive agents included in the multi-composite conductive agent 25, thereby maximizing the content of the anode active material 21 in the anode 20 and also maximizing the energy density of the lithium secondary battery.

The multi-composite conductive agent 25 according to the present disclosure improves the electrical conductivity and electron mobility in the anode 20, thereby improving rapid charging, high-power discharging, and lifespan characteristics of the lithium secondary battery. That is, by utilizing two or more types of conductive agents having different physical properties and shapes, the multi-composite conductive agent 25 according to the present disclosure can efficiently configure an electron transfer path, increase affinity with lithium ions, exhibit high electrical conductivity, and enable a stable supply of ions and electrons. As a result, the anode 20 containing the multi-composite conductive agent 25 according to the present disclosure can improve the rapid charging, high-power discharging, and lifespan characteristics of the lithium secondary battery.

### Embodiments and Comparative Example

In order to confirm the electrochemical characteristics of the anode containing the multi-composite conductive agent according to the present disclosure, anodes according to embodiments and a comparative example were prepared as follows.

Graphite was used as the anode active material.

Super-P, which is amorphous carbon, was used as the carbon-based conductive agent having a large specific surface area and high electrical conductivity. A silver nanowire was used as the metal-based conductive agent having both high electrical conductivity and lithium affinity.

In order to confirm a difference in electrode characteristics according to the physical properties and shapes of respective conductive agents and also check whether performance is improved when different types of conductive agents are combined, first to fourth embodiments respectively used, as the conductive agent, amorphous carbon (Super-P), silver (Ag) nanopowder, Ag nanowire, and a multi-composite conductive agent in which Super-P and Ag nanowire are mixed in a weight ratio of 3:1.

As a comparative example, an anode containing no conductive agent was prepared. That is, in the comparative example, the anode was prepared using only graphite.

In addition, as the binder, CMC and SBR were used together.

The composition of the anode according to the comparative example and the first to fourth embodiments is shown in Table 1.

TABLE 1

| | Anode active | | |
|---|---|---|---|
| | material | Conductive agent | Binder |
| Compar. example | graphite | — | CMC + SBR |
| 1^{st} embodiment | graphite | Super-P | CMC + SBR |
| 2^{nd} embodiment | graphite | Ag nanopowder | CMC + SBR |
| 3^{rd} embodiment | graphite | Ag nanowire | CMC + SBR |
| 4^{th} embodiment | graphite | Super-P + Ag nanowire | CMC + SBR |

The anode according to the comparative example was prepared in the form of a disc with a diameter of 12 mm by dissolving 98 wt % of graphite and 1 wt % of each of CMC and SBR as a binder in water to prepare a slurry, coating the slurry on a copper foil having a thickness of 10 μm, drying it, compressing it with a press, and then drying it in a vacuum at 80° C. for 12 hours.

The anodes according to the first to fourth embodiments were prepared in the same method as in the comparative example, using 97 wt % of graphite, 1 wt % of a conductive agent, and 1 wt % of each of CMC and SBR as a binder.

In order to examine the improvement of characteristics in the disclosure compared to the anode of a general lithium secondary battery, the L/L of the electrode and the mixture density were set to 9.0 mg/cm² and 1.5 g/cm³, respectively, and applied to five types of anodes according to the comparative example and the first to fourth embodiments.

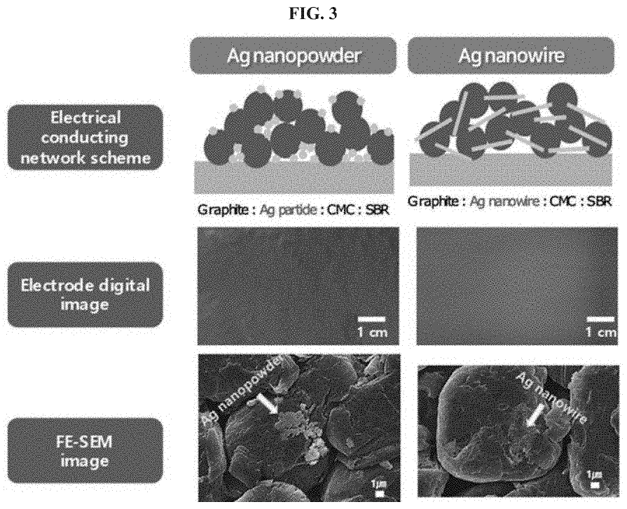

FIGS. 2 to 4 are photographs showing images of anodes according to a comparative example and embodiments. FIGS. 2 to 4 show the physical property analysis results of the anode according to the physical properties and shape of the conductive agent.

Referring to FIGS. 2 and 3, it can be seen that in the anodes according to the first to third embodiments, amorphous carbon particles, Ag nanopowder, and Ag nanowires are distributed between graphite particles, respectively.

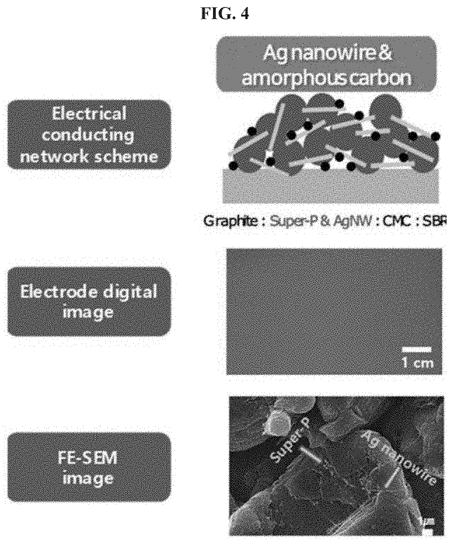

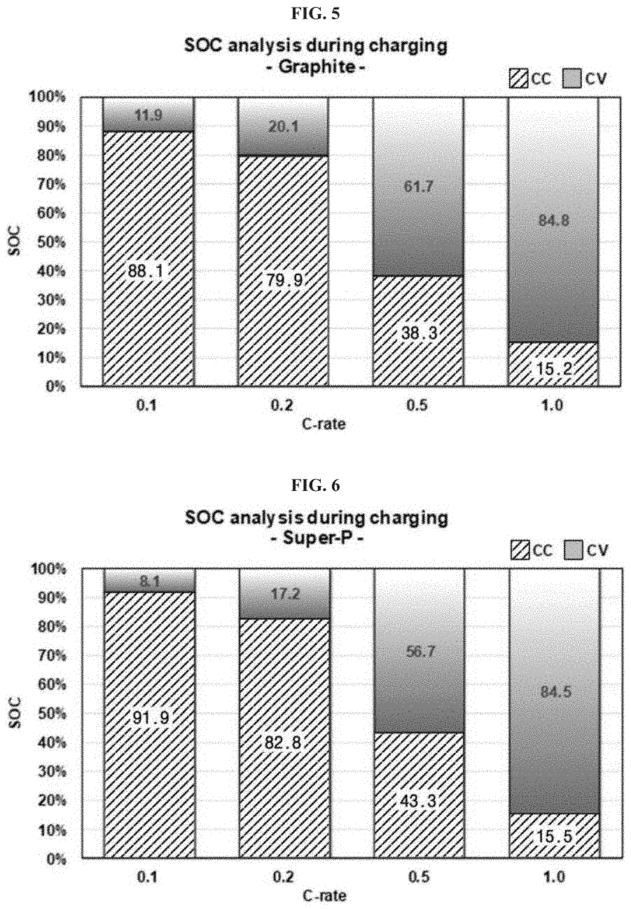

Referring to FIG. 4, it can be seen that in the anode according to the fourth embodiment, amorphous carbon particles and Ag nanowires are distributed together between graphite particles.

The results of measuring the electrical conductivity of the anodes according to the comparative example and the first to fourth embodiments are shown in Table 2 below.

TABLE 2

| | Compar. | 1^{st} | 2^{nd} | 3^{rd} | 4^{th} |
|---|---|---|---|---|---|
| | example | embodiment | embodiment | embodiment | embodiment |
| electrical | 0.5 | 1.8 | 2.0 | 2.1 | 3.1 |
| conductivity | | | | | |
| (S cm⁻¹) | | | | | |

Comparing the first to third embodiments in Table 2, it can be seen that Ag material used as the conductive agent has relatively higher electrical conductivity than amorphous carbon. Also, comparing the second and third embodiments, it can be seen that even in case of the same Ag material used as the conductive agent, nanowire having a relatively large specific surface area has relatively high electrical conductivity.

In addition, it can be seen that the fourth embodiment using amorphous carbon and Ag nanowires together as the conductive agent has higher electrical conductivity than the first to third embodiments. Furthermore, it can be seen that the anode according to the fourth embodiment has improved electrical conductivity by 6 times compared to the anode according to the comparative example having no conductive agent.

As can be seen in the SEM image of FIG. 4, the improvement in the electrical conductivity of the anode according to the fourth embodiment is because of a structure in which not only amorphous carbon maintains point bonds with graphite particles, but also silver nanowires having high electrical conductivity improve the overall electron mobility of the electrode.

The electrochemical properties of the lithium secondary batteries including anodes according to the comparative example and the embodiments were evaluated and compared.

Here, except for the second embodiment in which silver nanopowder, which exhibits relatively low electrical conductivity due to a difference in shape, is applied, the lithium secondary battery was prepared using the anode according to each of the comparative example and the first, third and fourth embodiments as a working electrode.

As a counter electrode and a reference electrode, a lithium metal foil punched into a diameter of 14 mm was used. As the separator, a PE film was used. As the electrolyte, a mixed solution of 1M LiPF₆ and EC/EMC at a ratio of 3:7 v/v was used.

After impregnating the separator with the electrolyte, the separator impregnated with the electrolyte was inserted between the working electrode and the counter electrode, and then a lithium secondary battery was prepared using a case (model name CR2032, manufactured by SUS).

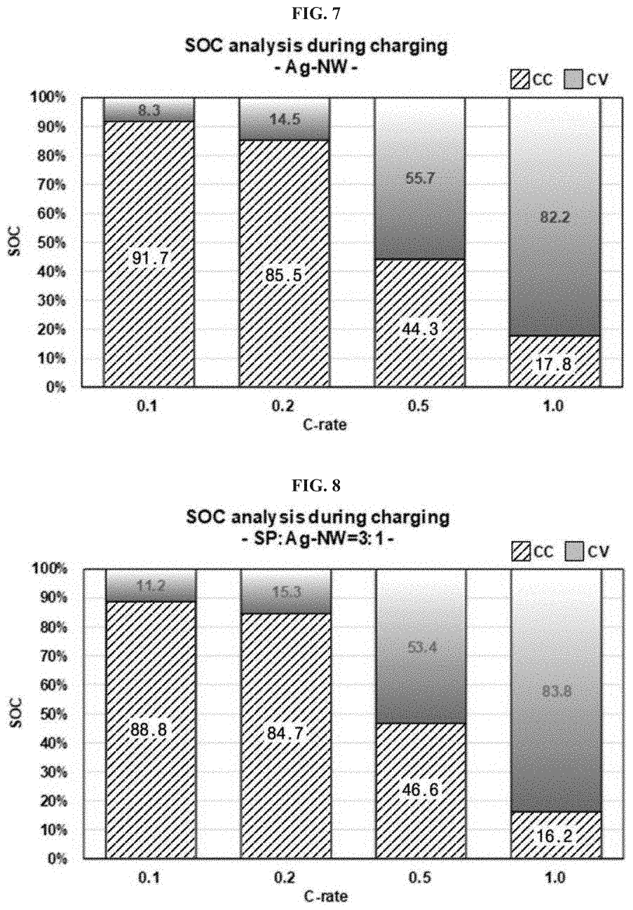

The lithium secondary batteries according to the comparative example and the embodiments were charged and discharged three times at 0.1 C in the range of 0.01 to 2.0V (vs. Li+/Li) under the condition of 25° C., and then the charging characteristics of the anode for each rate were evaluated. Evaluation results are shown in FIGS. 5 to 8. Here, the charging is the CC-CV method in which 0.1 C, 0.2 C, 0.5 C, 1.0 C, 2.0 C, and 3.0 C were applied. The discharging is the constant current method in which the same current of 0.2 C was applied.

FIGS. 5 to 8 are graphs showing CC/CV ratios in rate-by-rate charging of anodes according to a comparative example and embodiments.

Referring to FIGS. 5 to 8, different results could be obtained in rate-by-rate charging, depending on the type, shape, and composite or not of the conductive agent. When the conductive agent was applied, and in Ag nanowires rather than in amorphous carbon, it can be seen that the proportion occupied by the CC section increases in all C-rates. Because this means that the charging time at a higher current is increasing, it can be seen that the rapid charging characteristics are improved.

Meanwhile, the multi-composite conductive agent according to the fourth embodiment shows intermediate properties between amorphous carbon and silver nanowires, but considering the relatively small content of silver nanowires, the improvement in electrochemical properties is caused greater through the composite rather than each conductive agent.

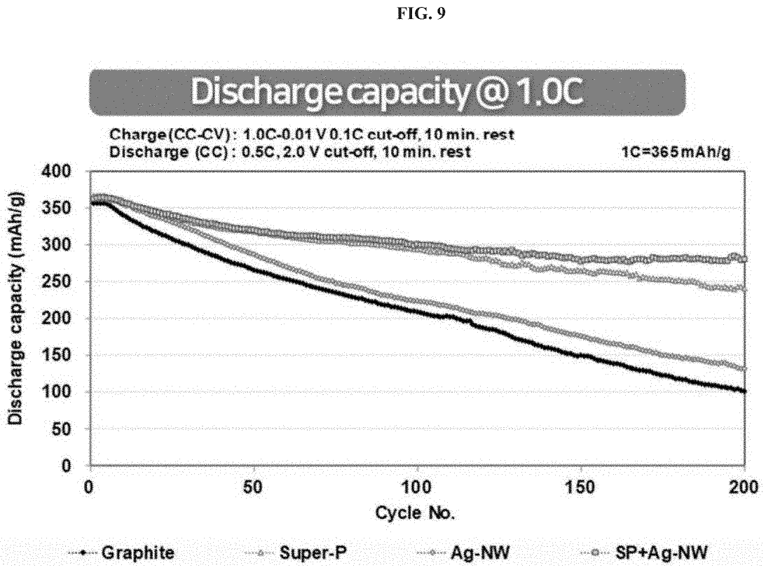

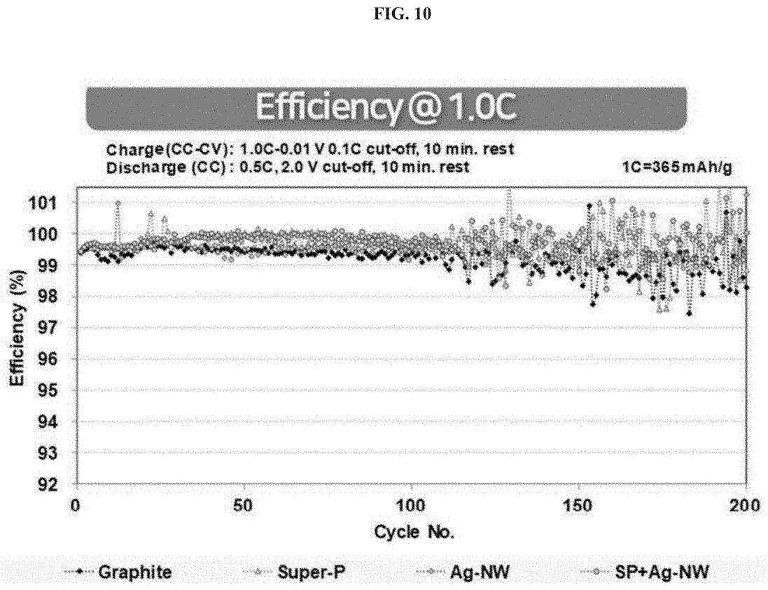

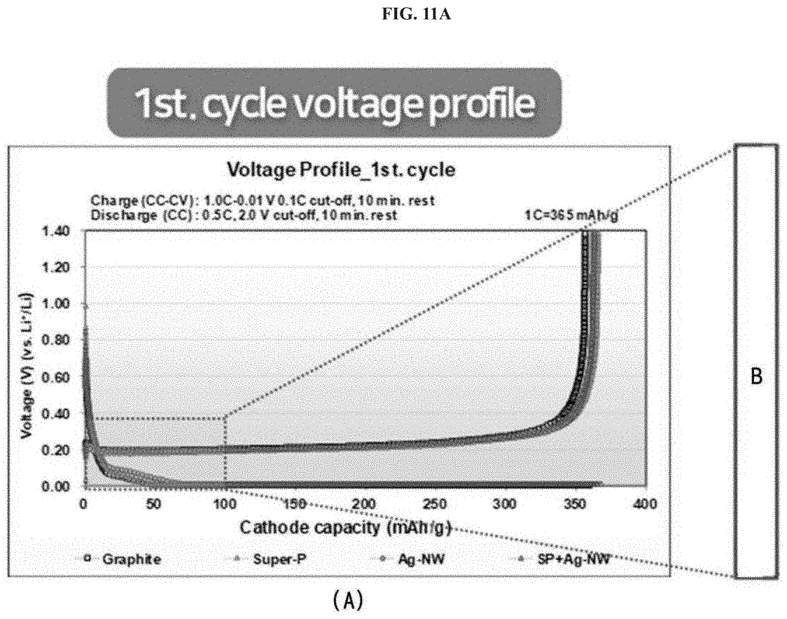

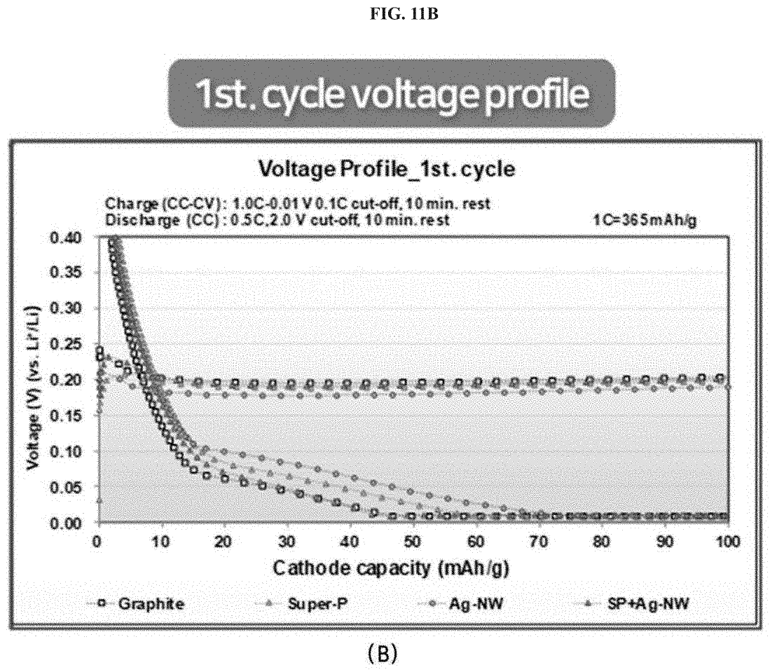

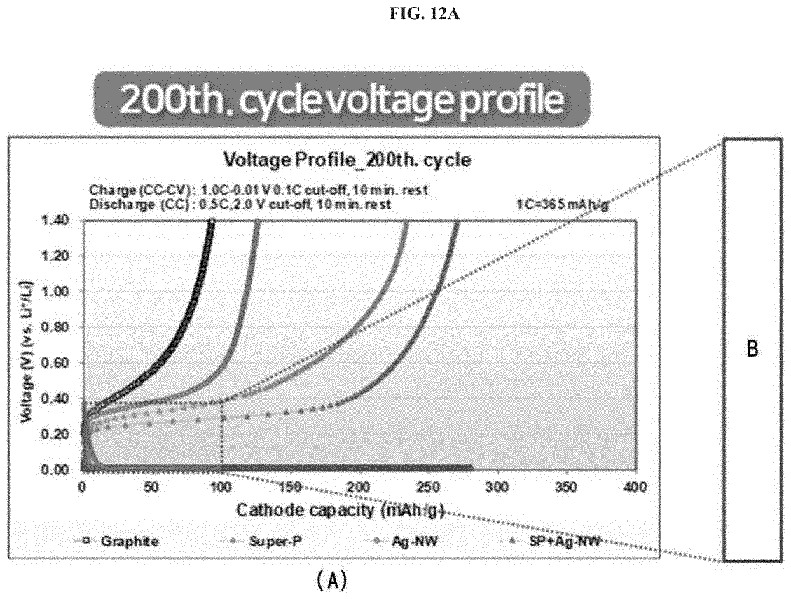

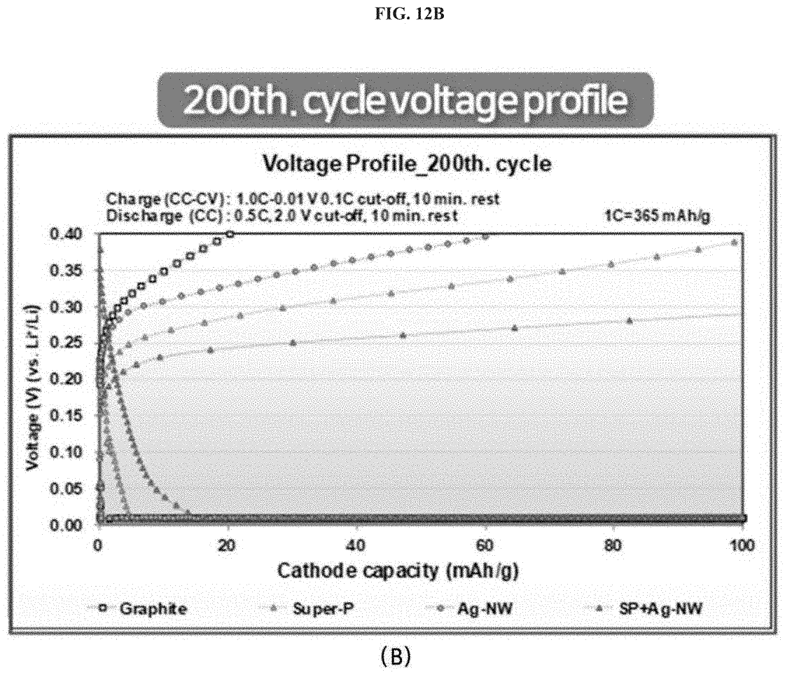

FIGS. 9 to 12B are graphs showing room temperature life characteristics of lithium secondary batteries including anodes according to a comparative example and embodiments, in which FIG. 9 is a graph showing discharge capacity, FIG. 10 is a graph showing capacity efficiency, FIGS. 11A and 11B are graphs showing a first cycle voltage profile, and FIGS. 12A and 12B are graphs showing a 200^{th} voltage profile.

As shown in FIGS. 9 to 12B, in order to confirm the room temperature life characteristics of the lithium secondary batteries according to the embodiments and the comparative example, the evaluation was performed by performing the charging in a constant current-constant voltage linkage method of 1.0 C in the range of 0.1˜2.0V (vs. Li+/Li) at 25° C. and then repeating the discharging of 0.5 C constant current 200 times

In the comparative example using no conductive agent, 30% or less of the initial capacity was maintained after 200 charge/discharge cycles.

On the other hand, in the first, third and fourth embodiments, it can be seen that the life retention rate was improved compared to the comparative example. Further, in the case of using the multi-composite conductive agent of the fourth embodiment, it can be seen that the capacity was maintained at 80% or more even after 200 repeated charge/discharge cycles.

From the above results, it can be seen that combining different types of conductive materials having different shapes and also using conductive materials having excellent electrical conductivity and lithium affinity can improve the rapid charging and high power characteristics of the lithium secondary battery and also improve lifespan stability at a high rate. That is, when conductive agents having excellent electrical conductivity and different shapes are applied in combination, the movement of electrons in the anode is smooth, and the mobility of ions is improved by a conductive agent with high lithium affinity. As a result, this improves the electrochemical performance of the lithium secondary battery.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. An anode for a lithium secondary battery, comprising:
an anode active material comprising a carbon-based material and a metal-based compound;
a binder; and
a multi-composite conductive agent comprising a carbon-based conductive agent and a metal-based conductive agent having different physical properties and shapes.

2. The anode of claim 1, wherein the carbon-based material includes at least one of graphite, soft carbon, or hard carbon, and
wherein the metal-based compound includes at least one of a silicon compound, a tin compound, or a zinc compound.

3. The anode of claim 2, wherein the multi-composite conductive agent includes at least one of Super-P, denka black, graphene, carbon nanofibers (CNF), or carbon nanotubes (CNT) as the carbon-based conductive agent, and includes at least one of Ag, Au, Ca, Zn, Al, or alloys thereof as the metal-based conductive agent.

4. The anode of claim 3, wherein the carbon-based conductive agent and the metal-based conductive agent have different shapes,
wherein the carbon-based conductive agent has one of a particle shape, a fiber shape, or a tube shape, and
wherein the metal-based conductive agent has one of a particle shape, a fiber shape, a wire shape, or a flake shape.

5. The anode of claim 3, wherein the carbon-based conductive agent comprises a nanoparticle, and the metal-based conductive agent comprises a nanowire.

6. The anode of claim 5, wherein in the multi-composite conductive agent, a content of the carbon-based conductive agent is higher than a content of the metal-based conductive agent.

7. The anode of claim 1, wherein the anode active material is 97 wt % or more, wherein the binder is 2 wt % or less, wherein the multi-composite conductive agent is 1 wt % or less, and wherein a content of the binder is higher than a content of the multi-composite conductive agent.

8. The anode of claim 1, wherein the carbon-based material comprises graphite, wherein the metal-based compound comprises a silicon compound, wherein the carbon-based conductive agent comprises Super-P, and wherein the metal-based conductive agent comprises an Ag nanowire.

9. A lithium secondary battery comprising:
an anode, a cathode, a separator, and an electrolyte,
the anode including:
an anode active material comprising a carbon-based material and a metal-based compound;
a binder; and
a multi-composite conductive agent comprising a carbon-based conductive agent and a metal-based conductive agent having different physical properties and shapes.

10. The lithium secondary battery of claim 9, wherein the carbon-based material includes at least one of graphite, soft carbon, or hard carbon, and
wherein the metal-based compound includes at least one of a silicon compound, a tin compound, or a zinc compound.

11. The lithium secondary battery of claim 10, wherein the multi-composite conductive agent includes at least one of Super-P, denka black, graphene, carbon nanofibers (CNF), or carbon nanotubes (CNT) as the carbon-based conductive agent, and includes at least one of Ag, Au, Ca, Zn, Al, or alloys thereof as the metal-based conductive agent.

12. The lithium secondary battery of claim 11, wherein the carbon-based conductive agent and the metal-based conductive agent have different shapes,
wherein the carbon-based conductive agent has one of a particle shape, a fiber shape, or a tube shape, and
wherein the metal-based conductive agent has one of a particle shape, a fiber shape, a wire shape, or a flake shape.
